(19) United States
(12) Patent Application Publication
(10) Pub. No.: US 2011/0219712 A1
(43) Pub. Date: Sep. 15, 2011

(54) METHOD AND SYSTEM FOR TWISTING BUILDING STRUCTURE

(75) Inventors: Matthew CLARK, New York, NY (US); David Scott, New York, NY (US)

(73) Assignee: ARUP, New York, NY (US)

(21) Appl. No.: 13/114,778

(22) Filed: May 24, 2011

Related U.S. Application Data
(63) Continuation of application No. 12/362,215, filed on Jan. 29, 2009.
(60) Provisional application No. 61/006,723, filed on Jan. 29, 2008.

(51) Int. Cl. E04H 1/00; E04H 14/00; E04B 1/00; G06F 17/50

(52) U.S. Cl. 52/236.3; 52/741.1; 703/1

(57) ABSTRACT

A structure and method of designing and constructing a building that includes a core wall structure, a plurality of support walls attached to and cantilevered from the core wall structure, a plurality of floor structures arranged vertically and attached to the core wall structure so that each floor structure of the plurality of floor structures is supported from below by a first set of the plurality of support walls and from above by a second set of the plurality of support walls, a position of the second set of the plurality of support walls radially offset from a position of the first set of the plurality of support walls, and a plurality of openings in the core wall, wherein at least one opening is provided between any two successive floor structures and alternating openings in a vertical direction are arranged to align along an angle of vertical offset.

### CROSS-REFERENCE TO RELATED APPLICATION

This application is a Continuation Application of U.S. patent application Ser. No. 12/362,215, filed Jan. 29, 2009, and claims priority to U.S. Provisional Patent Application No. 61/006,723 filed Jan. 29, 2008, both titled “METHOD AND SYSTEM FOR TWISTING BUILDING STRUCTURE,” the entirety of each which is incorporated by reference herein.

### BACKGROUND OF THE INVENTION

1. Field of the Invention

The present invention relates to the field of structural engineering, and, in particular, to methods and systems for designing, building, and/or providing structural support for buildings having a twisting external appearance.

2. Background of the Technology

Certain architectural fashions have led to desirability for tall buildings that twist. However, such related art twisting towers are notoriously expensive, at least in part because the inclined columns and alignment of openings in the core wall for most designs creates large torsions that usually lead to the necessity for very thick core walls and/or some form of external bracing. The twisting inclined columns are also typically very difficult to build because these features generate more twisting force as the load is applied. As a result, related art designs have increased costs related to risk, design details and increased material quantities.

Essentially, two approaches have been taken in the related art. FIGS. 1A-1B show representative perspective and overhead views, respectively, of a building B1 constructed using a first approach, in which support columns C1 are angled to connect corresponding portions of pairs of floors F1 and F2. The radius of twist between floors in FIGS. 1A-1B of about 45° is much greater than in a typical related art building, and the columns C1 are not likely to be designed to connect to the extreme corners of twisting floors, as shown in FIGS. 1A-1B. The angle and position of columns C1 shown in FIGS. 1A-1B are merely intended to be representative and to illustrate the problem. Among other problems, the approach depicted in FIGS. 1A-1B typically results in a torsional force being generated about the building through the angled columns. As the load on the floors F1, F2 increases, the torsional force increases, thereby placing torsional force on the building B1 (including on the core structure) in the twisting direction. Resolution of the torsional force results in an increase in structural material quantities (within the core, or secondary bracing system) that increases the cost of the structure significantly beyond that of typical building structures of comparable size. Further, the aesthetic appeal of buildings using the design depicted in FIGS. 1A-1B may be negatively impacted due to the increased inconvenience and space occupied by the structure as a result of a requirement for additional structural elements beyond that of typical building structures of equivalent size.

FIGS. 1C-1E show representative perspective and overhead views, at differing floor levels, of a building B2 constructed using a second approach, in which support columns C2 are vertical through the entire height of the building and connect pairs of floors F3 and F4. The radius of twist between floors in FIGS. 1C-1E of about 45° is much greater than in a typical related art building, and columns C2 may be located further from the center of twisting floors than shown in FIGS. 1C-1E. The positions of columns C2 shown in FIGS. 1C-1E are merely intended to be representative and to illustrate the problem. Among other problems, the approach illustrated in FIGS. 1C-1E results in column locations varying between floors F3, F4, effectively “rotating” through rooms within the floors F3, F4 as viewed through successive floors, thereby resulting in differing room layouts, relative to column locations, on each floor (a problem potentially further exacerbated with smaller angles of rotation than the angle shown in FIGS. 1C-1E). Further, the floors require additional material to achieve the cantilevers beyond the columns which are providing the appearance of the twist. If efficiency is desirable, the magnitude of difference between the floors may be restricted due to limited cantilever lengths. This approach can be thus aesthetically unappealing because the articulation of the form is limited.

FIGS. 2A-2C contain representative diagrams and indications of typical forces affecting straight buildings (FIG. 2A), a comparison between such forces and the first approach discussed above (FIG. 2B), and a comparison between such forces and the second approach discussed above (FIG. 2C), further to the figures and discussion with respect to FIGS. 1A-1E.

FIGS. 2D-2K present various cutaway and other views and renderings of example related art buildings of the first approach outlined above.

Related art solutions to the problem have typically involved use of additional braced frames, thicker core walls, and/or traditional cantilevers, and thus contain a compromise on either economy or planning flexibility.

Twisting residential buildings have become desirable, but current known structural engineering solutions require compromises and are deficient, as stated above. Thus, currently, many projects are not realized in their original envisaged form, due to these problems. Because of the above identified problems, as well as others, buildings of the related art are not popular in design. There remains an unmet need in the art for methods and systems for designing, constructing, and providing structural support for twisting buildings that overcome the torsional and aesthetic problems of the related art.

### SUMMARY OF THE INVENTION

Aspects of the present invention overcome the above identified problems of the related art, as well as others, by providing methods and systems for designing, building, and/or providing structural support for twisting buildings, such that these buildings may be erected using conventional vertical and horizontal elements. Aspects of the present invention avoid reductions in the interior space or disruption of general interior symmetry that would otherwise occur in the related art due to the need for additional structural material and/or design compromises. The methods and systems of aspects of the present invention thereby provide a new dimension for enabling architects to create economically feasible designs for twisting towers and other building shapes, based on the basic methods and systems disclosed herein.

In aspects of the present invention, the methods and systems include at least three features:

a) Alternate floor plates. Every floor is supported from below and above.

b) Cantilever forces resisted by diaphragm action. The floor plates are supported from fin walls, or trusses, which cantilever from a central core. The push-pull from the cantilever forces balance within each diaphragm level. The twist is created by translating the fin walls or trusses around the core.

c) Lateral Support. The lateral forces are resisted by a core wall only. The alternate floor arrangement means that penetrations through the floor do not align, which means that lintel beams are deep and effective.

Aspects of the present invention provide at least the following at least the following features: alternating the floor plates at about 180 degrees (plus the desired twist angle), or design of two mutually supporting floor plates (A&B) which alternate with respect to height; full depth cantilevers, placed in division walls, to support floors above and below; and floor diaphragms used to resolve cantilever bending forces in place of traditional back-spans for cantilevers

Aspects of the present invention allow the twisting building to be designed and constructed at equivalent costs to traditional buildings of approximately the same size. Furthermore, aspects of the present invention include a method of designing a building structure on a tangible medium through geometric illustration of the features of the building structure and the relationship of those features to each other.

Example aspects of the present invention will now be described in accordance with the above advantages. It will be appreciated that the examples described in the following detailed description are merely illustrative of the invention. Many variations and modifications will be apparent to those skilled in the art.

### BRIEF DESCRIPTION OF THE FIGURES

In the drawings:

FIGS. 1A-1B show representative perspective and overhead views, respectively, of a building constructed using a first related art approach, in which support columns are angled to connect corresponding portions of pairs of floors;

FIGS. 1C-1E show representative perspective and overhead views, at differing floor levels, respectively, of a building constructed using a second related art approach, in which support columns are vertical through the entire height of the building and connect pairs of floors;

FIGS. 2A-2C contain representative diagrams and indications of typical force issues affecting buildings of the related art;

FIGS. 2D-2K present various cutaway and other views and renderings of example buildings of the first related art approach;

FIGS. 3 and 4 show perspective and overhead views of a representative twisting round profile building provided for illustration purposes, in accordance with aspects of the present invention;

FIG. 5A shows a view of the central core for the building of FIGS. 3 and 4;

FIGS. 5B and 5C show renderings of the core of FIG. 5A, in accordance with aspects of the present invention;

FIG. 5D presents modeled results stress for the core of FIG. 5A, in accordance with aspects of the present invention;

FIGS. 6A and 6B present overhead views of a generally almond shaped floor profile, in accordance with aspects of the present invention;

FIGS. 7A-7C show features and views of a generally tear-drop shaped profile for floors a various aspects of implementation relating thereto, in accordance with aspects of the present invention;

FIG. 8 shows cantilever walls of varying length, in accordance with aspects of the present invention;

FIGS. 9-11 show perspective and overhead views of a pentagon-shaped profile for floors in a twisting building, in accordance with aspects of the present invention;

FIGS. 12A-12C show perspective views of an exemplary building designed in accordance with aspects of the present invention;

FIG. 13 shows a rendering of a 100° twist as applied to a conventional building with a generally tear-drop shaped cross-sectional profile and vertically aligned doors, in accordance with aspects of the present invention;

FIG. 14 shows a rendering of a 60° increasing twist as applied to a conventional building with a generally tear-drop shaped cross-sectional profile and vertically aligned doors, in accordance with aspects of the present invention;

FIG. 15 shows a rendering of a 60° twist (only the tip columns rotate) as applied to a conventional building with a generally tear-drop shaped cross-sectional profile having vertically aligned doors, in accordance with aspects of the present invention; and

FIGS. 16A and 16B show a rendering of a central core in which the doors are aligned vertically and staggered on alternating floors, respectively, in accordance with aspects of the present invention.

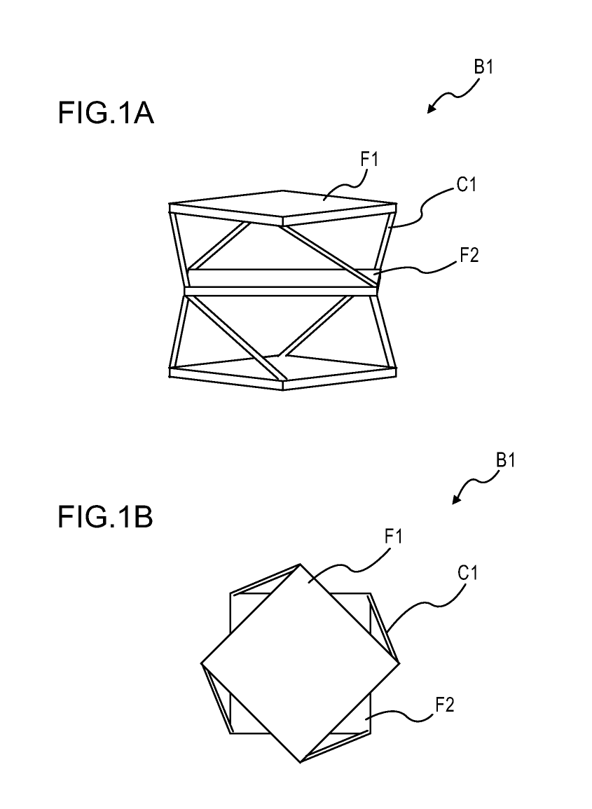

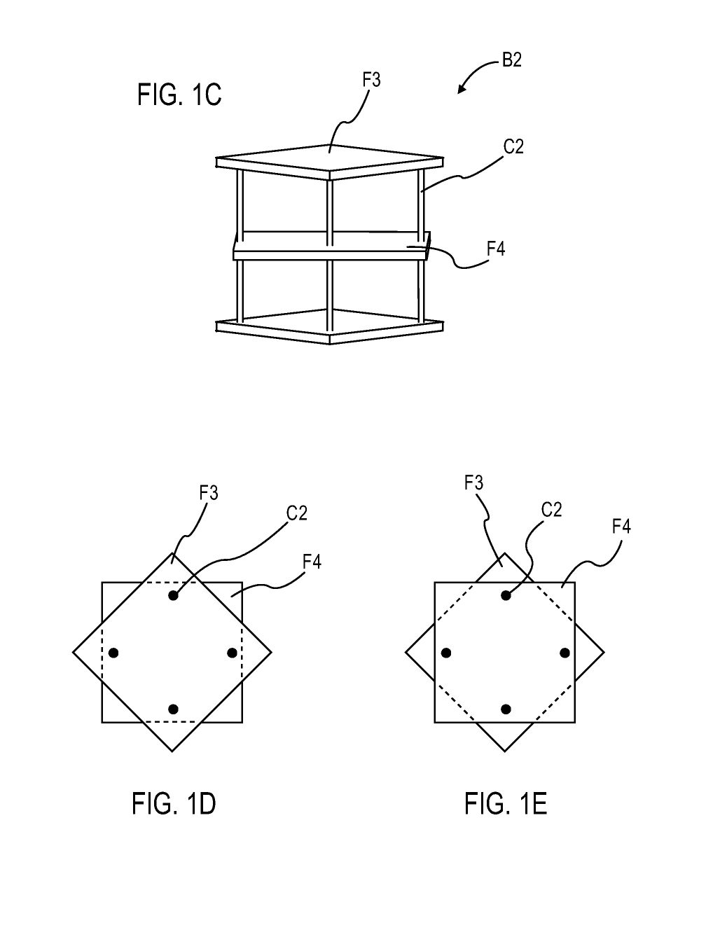

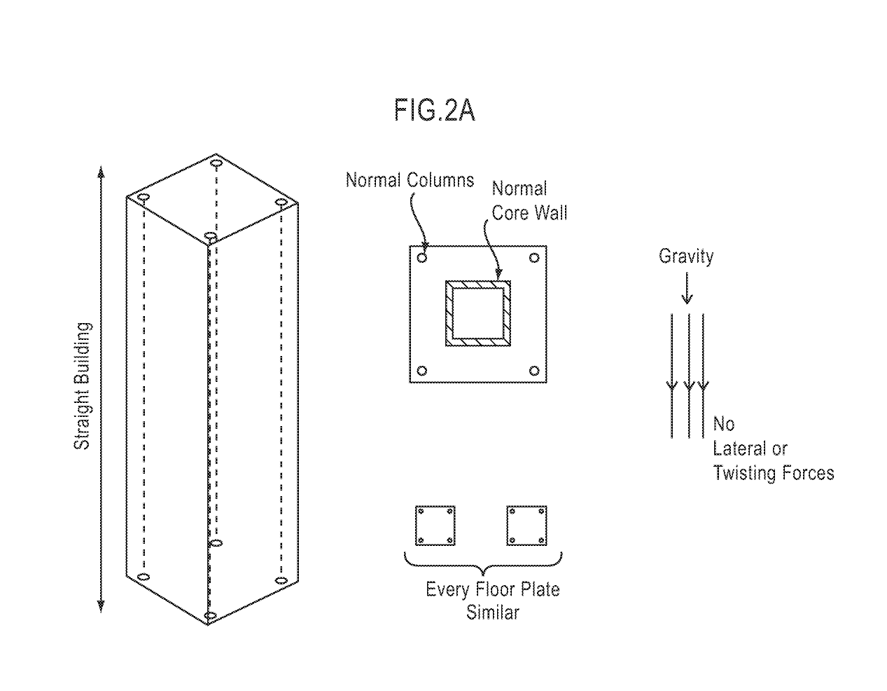

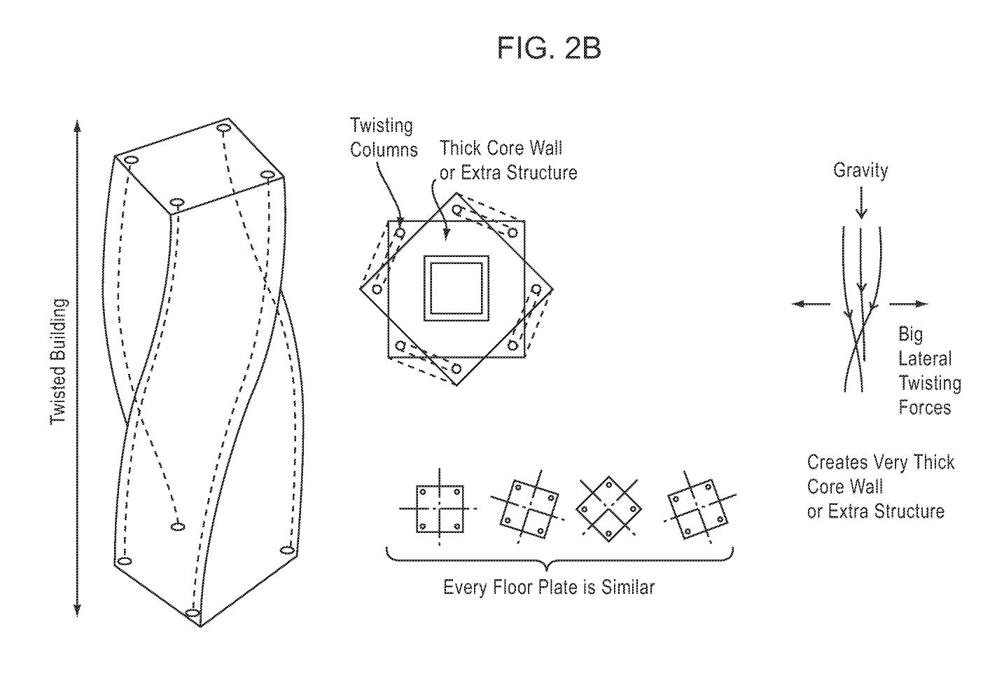

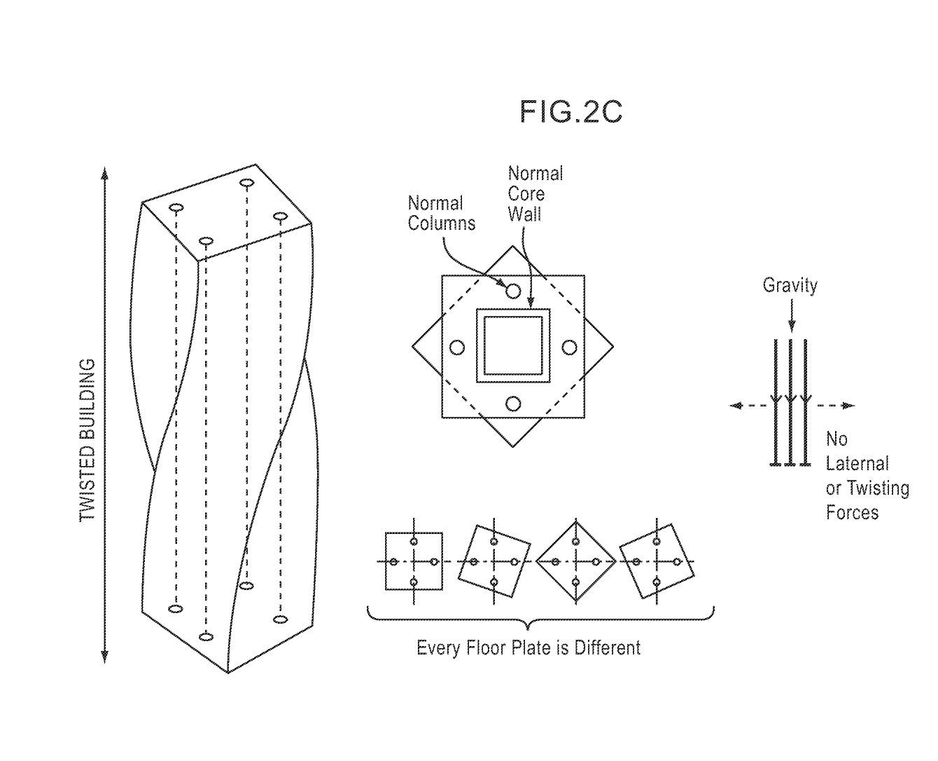

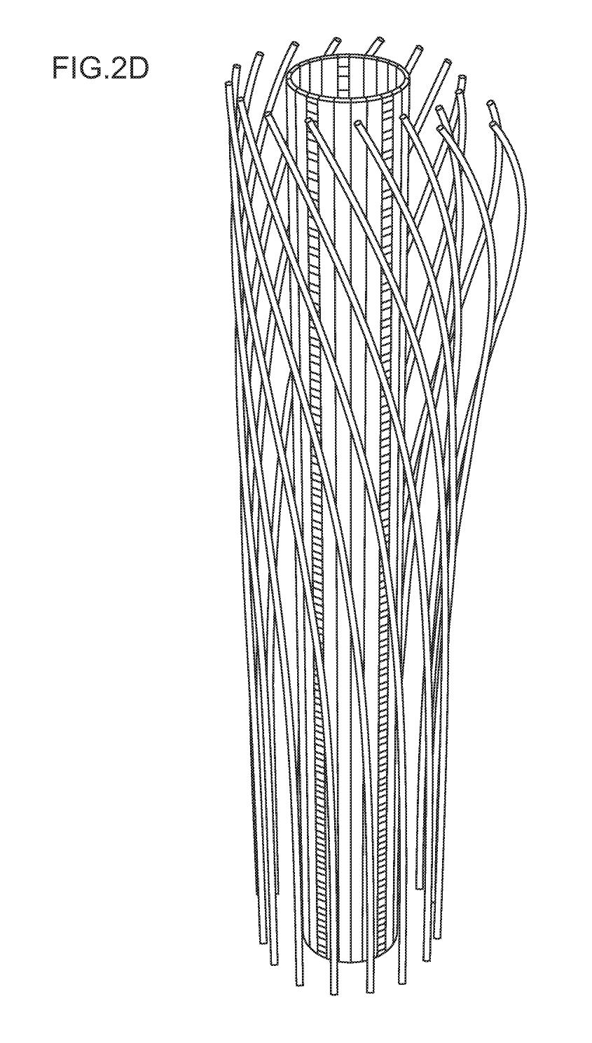

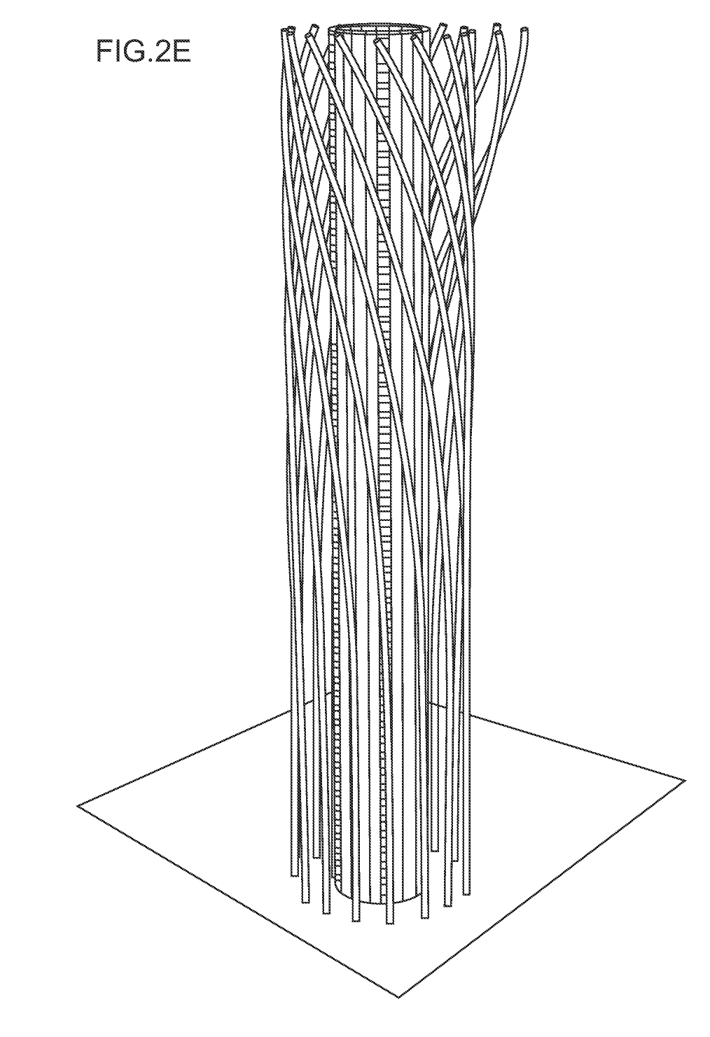

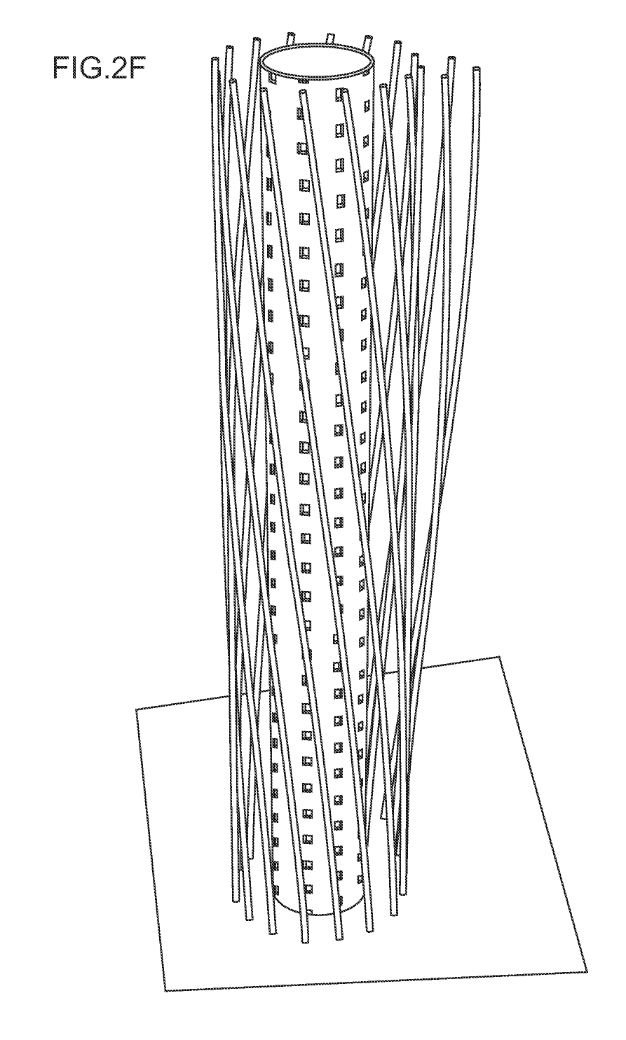

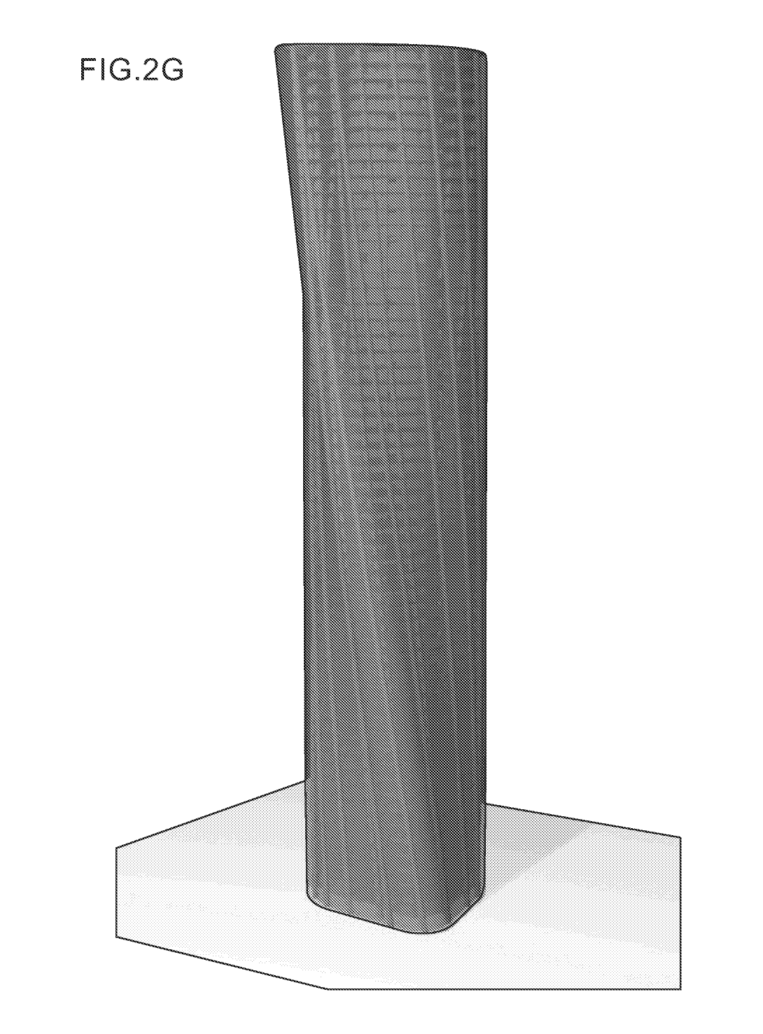

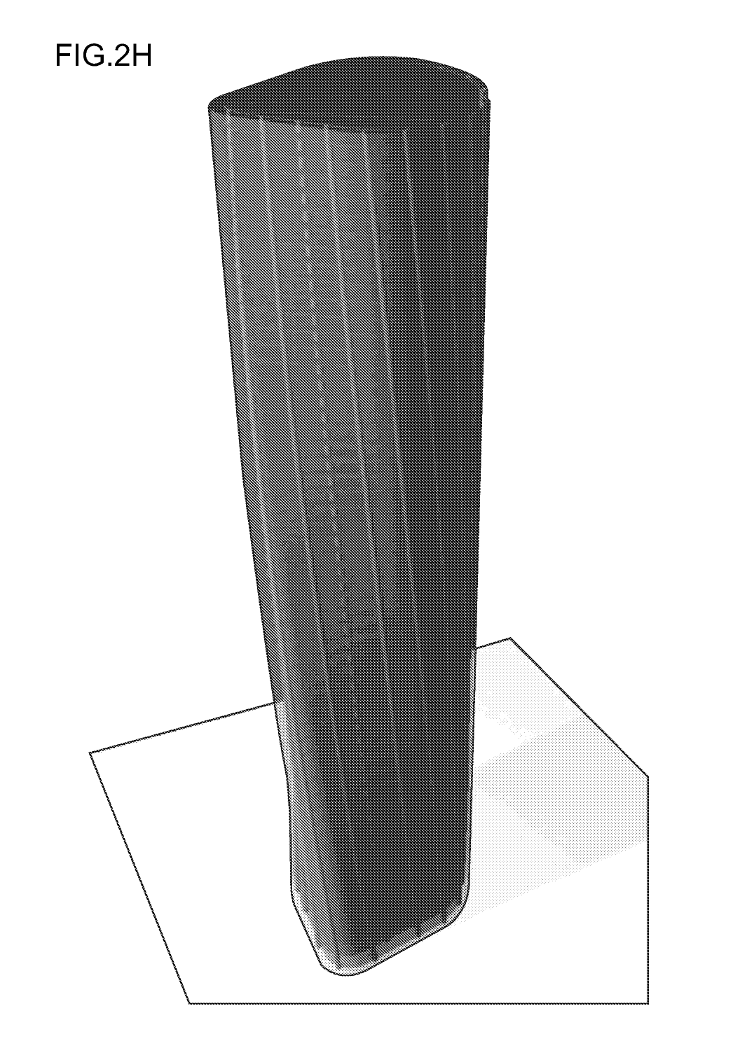

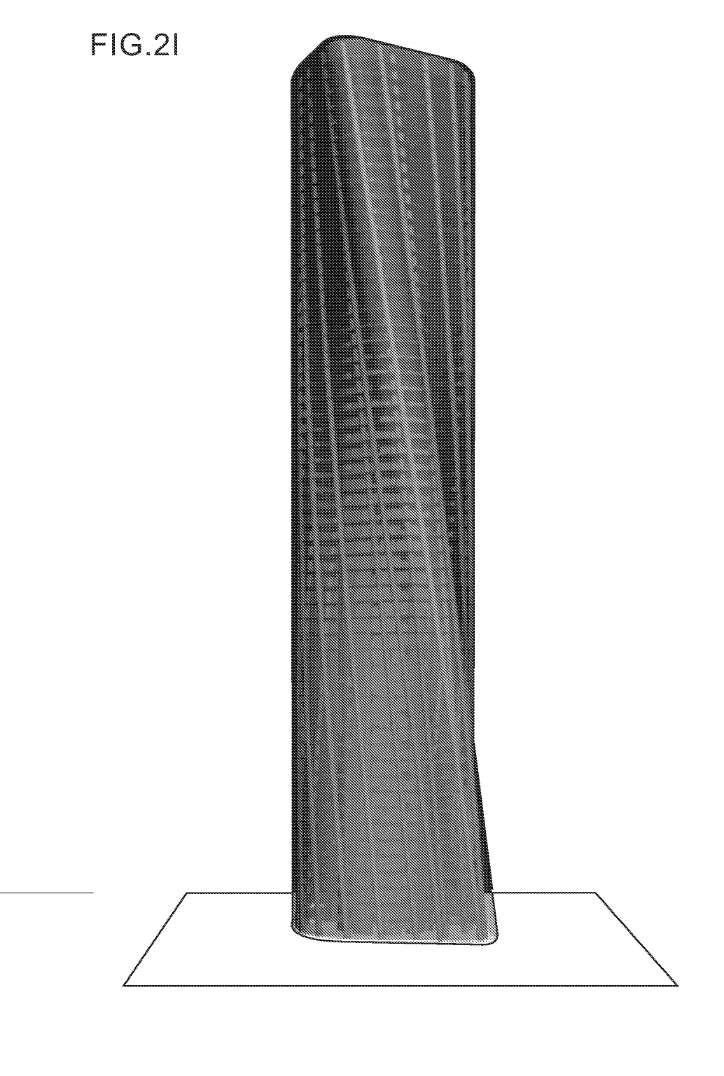

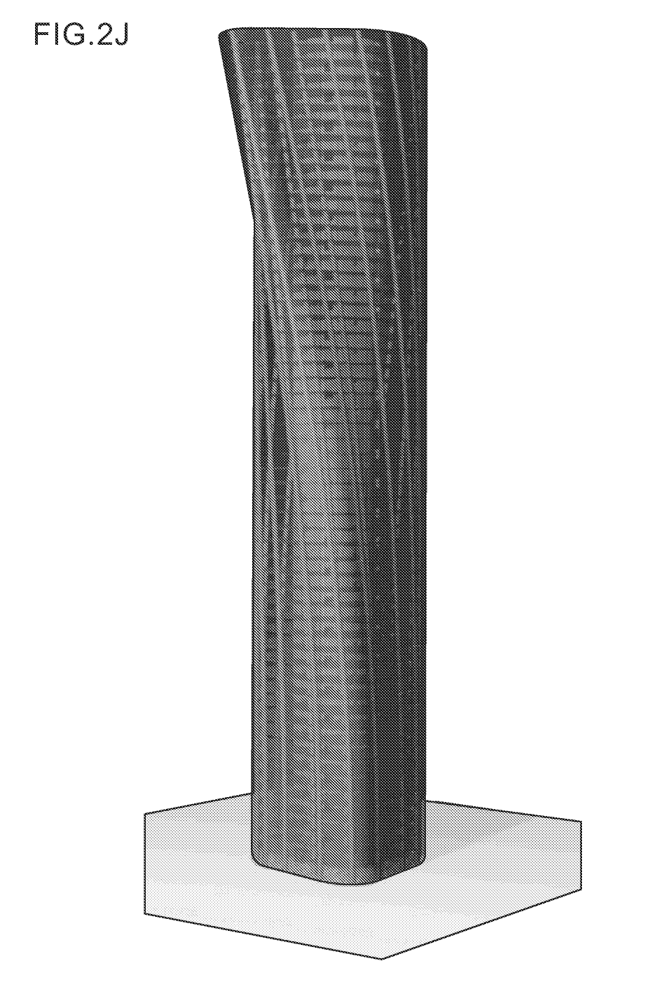

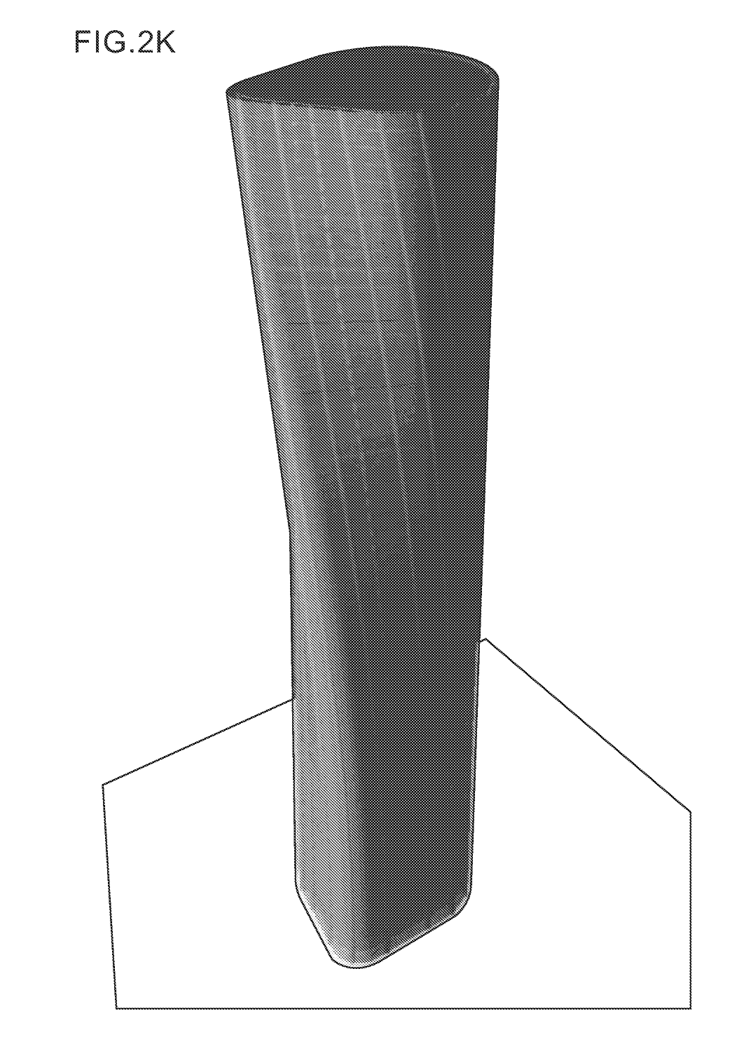

### DETAILED DESCRIPTION

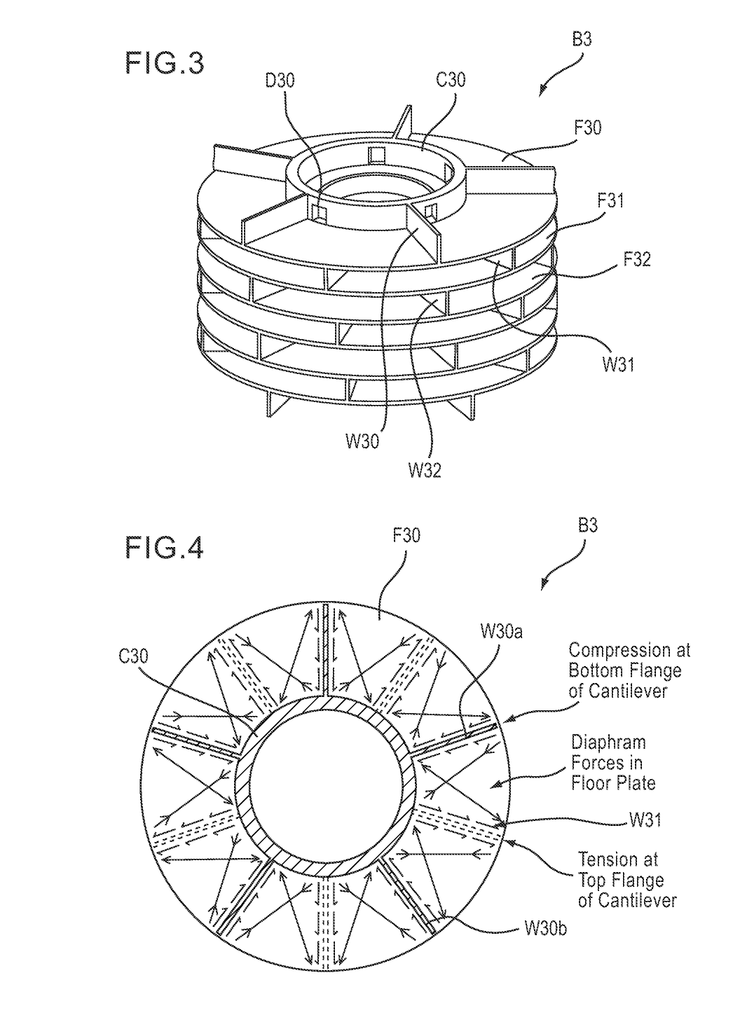

FIGS. 3 and 4 show perspective and overhead views, respectively, of a representative twisting structure B3 having generally circularly shaped floor plans, which are provided for illustration purposes, in accordance with aspects of the present invention. As shown in FIG. 3, floors F30, F31, and F32 each are shown with five thin walls W30, W31, W32 and a central core C30. Openings (e.g., doors) D30 are positioned in core C30 between each sequential pair of floors (e.g., between floors F30 and F31). While five cantilever walls for each floor are shown in the variation of FIGS. 3 and 4, as few as three walls for each floor may be sufficient for other variations. Such variations may be convenient for residential use buildings, where the cantilever walls can be coordinated with the desired apartment layouts, but also may be suitable for any other use building where the partition of the space is suitable, or open trusses are used in the cantilever positions allowing passage through the cantilevers.

The arrangement, as shown in FIGS. 3 and 4, may be realized in a variety of structural materials such as a reinforced concrete, post-tensioned concrete, and steel framing with concrete on steel deck floors, among others. The choice of structural material is dependent on the scale and dimensions of the structure and associated requirements. The use of the terminology ‘cantilever walls’ refers to the wall positions where a structural concrete cantilever, or steel truss cantilever may be placed.

As shown in FIG. 3, alternative pairs of floors (e.g., F30, F32) have nearly aligned cantilever walls (e.g., W30, W32, respectively). For each floor (e.g., F30), walls for that floor (e.g., W30), along with walls for the floor below that floor (e.g., W31), together support the floor (e.g., F30).

As further shown in FIG. 4, the cantilever walls W30a, W31, W30b are subject to shear forces and cantilever bending forces by virtue of gravity and their attachment to central core C30 and floor F30. The walls W30a, W30b support floor F30 from above, as shown. The weight of the floor is transferred to the core as shear force. The geometry of the load path results in cantilever bending forces. Since floor F30 is attached to the base of walls W30a & W30b, a force acts towards the core. This force is resolved through the floor F30 in diaphragm action, and is balanced by similar forces acting towards and away from the core at the other wall positions of floor F30. The wall W31 supports floor F30 from below as shown. The geometry of the load path results in cantilever bending forces. Since the floor F30 is attached to the base of wall W31, a force acts away from the core. This force is resolved through the floor F30 in diaphragm action and is balanced by similar forces acting towards and away from the core at the other wall positions of floor F30. In some aspects, the walls W30a, W31, W30b may be as thin as 150 mm/6 inches in width.

As a result of the use of such a cantilever wall arrangement, columns within the floors are not required, thereby improving room space utilization, due to both the lack of columns, and the resulting consistent large room size and open layout of floor space. For example, each room may form an apartment that has a relatively large open space (e.g., 10 m×20 m) uninterrupted by columns, as compared to typical related art apartments in conventional residential buildings (typically having a column to be addressed at 8 m intervals or less). Among other advantages, the large open spaces uninterrupted by columns can greatly increase the value of the apartments and/or building as a whole. As such, aspects of the present invention may also be used in a straight (not twisted) structure. The novel aspects of the present invention permit construction of a structure with or without a twist, at little or no cost differential. The feature of space uninterrupted by columns remains an advantage in either case.

Further, and particular in the case of concrete-framed construction, because of the combined cantilever wall support and the spacing of the supports for each floor from both below and above, a floor structure of each floor can be quite thin, relative to the thickness of related art floor structures for a typical building application. With the addition of a perimeter beam, the floor structures may be a 2-way slab system rather than a flat plate system typically used for floor construction in conventional applications. The 2-way slab system requires less concrete material than the flat plate system for equivalent spans. Among other things, the reduced floor thickness, in conjunction with use of cantilever walls, reduces the overall building weight and the stress on the building support structure (e.g., the central core).

In addition to use of structural concrete cantilever walls, steel or other suitable material trusses may be used in the position of the cantilever walls. The truss structures would be cantilever trusses connecting the floor above, the floor below and the central core with sufficient stiffness and strength following standard structural principles.

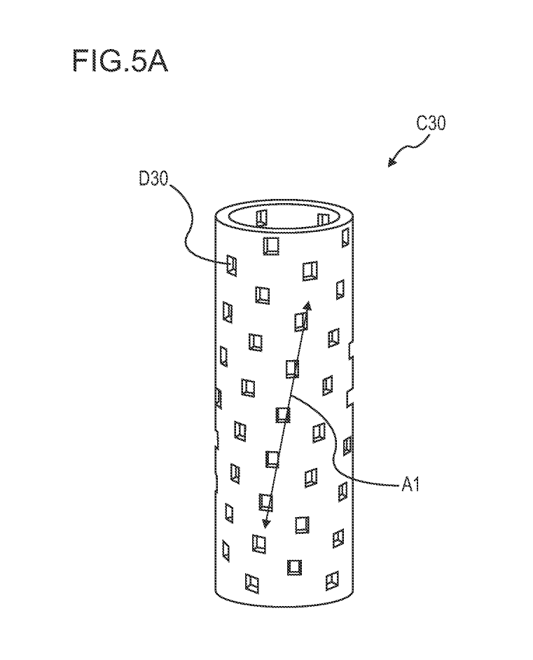

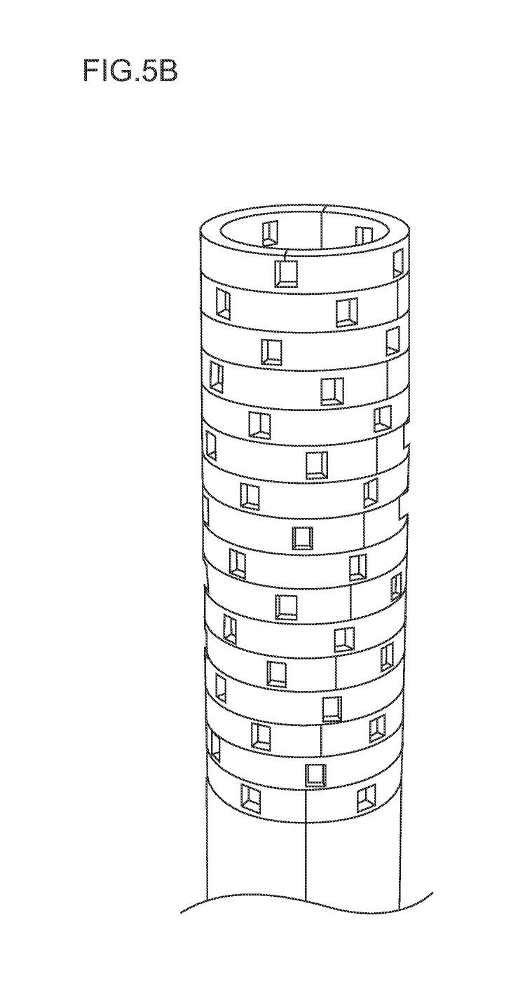

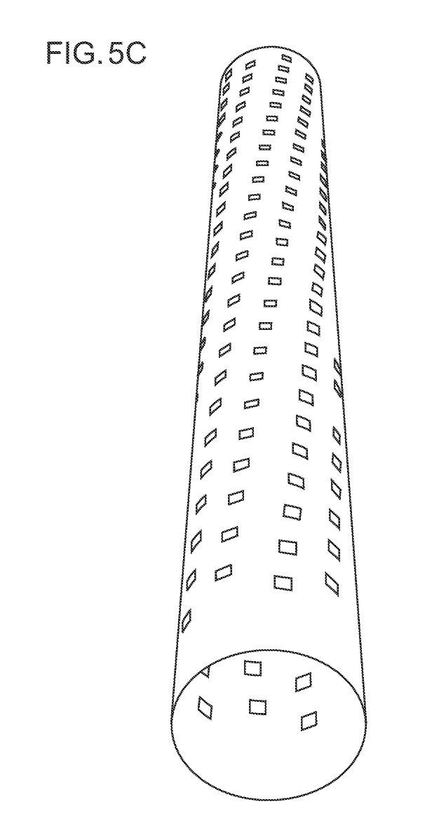

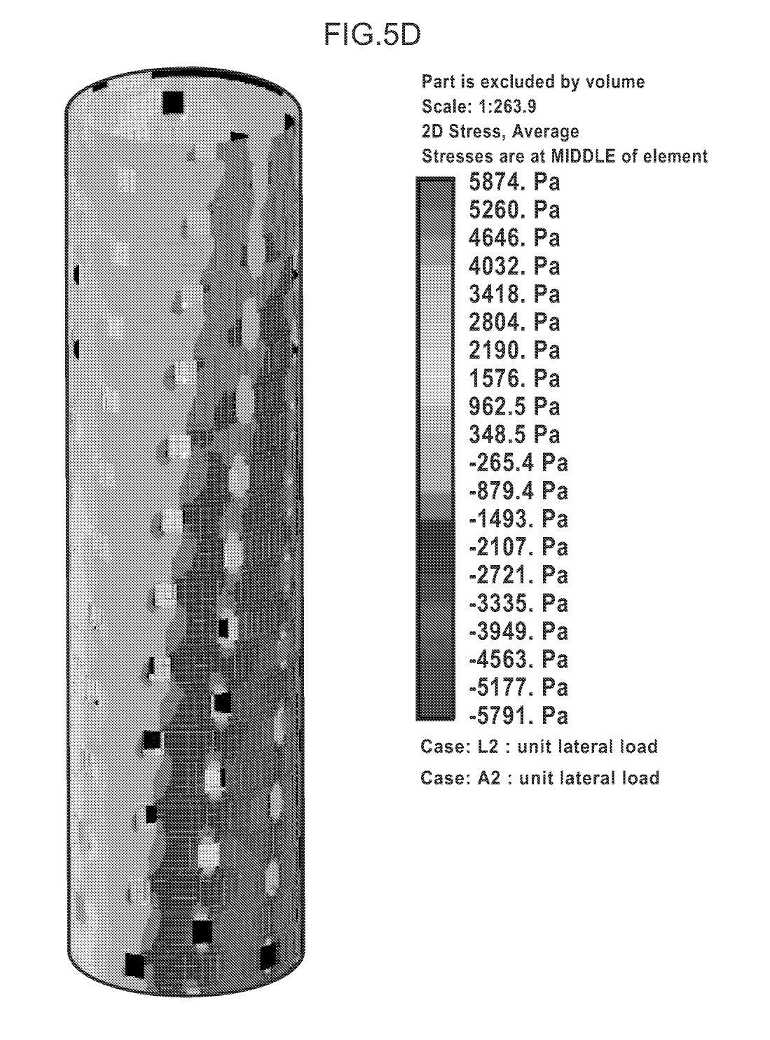

FIG. 5A shows a view of the central core C30 for the building B3 of FIGS. 3 and 4, with openings D30 (e.g., doors) shown. As shown in FIG. 5A, the doors D30 are not aligned vertically. Rather, the doors D30 of alternating floors are generally aligned along an angled vertical offset (e.g., angled line A1) which is equal to the desired twist of the building. Arranging the doors according to an even and odd floor staggered arrangement, the corresponding openings D30 may be positioned on opposite sides for sequential floors. As such, the corresponding openings D30 on an even floor may be offset as compared to the openings D30 on an odd floor in similar fashion or degree to the offset of the cantilever walls between an even and an odd floor. For example, the open space (e.g., apartment) on any one floor may be offset by a length equal to nearly half of the open space of the floor above or below, including the offset due to a twist, by positioning of the cantilever walls. As such, the openings D30 on successive floors may be generally offset to be nearly equal to half of the length of an open space, for example. Among other advantages, arrangement of the openings D30 in this manner increases the stiffness and strength of the central core C30, relative to a related art core, in which each floor has an opening aligned in a vertical line or angled line for every floor. Such an arrangement in related art cores reduces the stiffness and strength of the core along such lines. In related art cores, the lintel beams created by aligned doorways on adjacent floors can often, dependent upon the exact situation, require a high density of material and reinforcement due to the forces the lintel beams attract as the building moves under lateral loads. In aspects of the present invention, the shallow lintel beams may be removed to alleviate the associated stress.

In the interior of the central core C30 (e.g., in the area within the concave side of the wall of the central core C30, as shown in FIG. 4) may be located elevators, stairways, mechanical rooms, vertical risers, plumbing, electrical, and/or other features common to the interior of the building. Aspects of the central core C30 of a building in accordance with aspects of the present invention may be similar to aspects of an equivalent building as is typical in the related art.

FIGS. 5B and 5C show renderings of the central core of FIG. 5A. FIG. 5D presents modeled results of stress for the core of FIG. 5A.

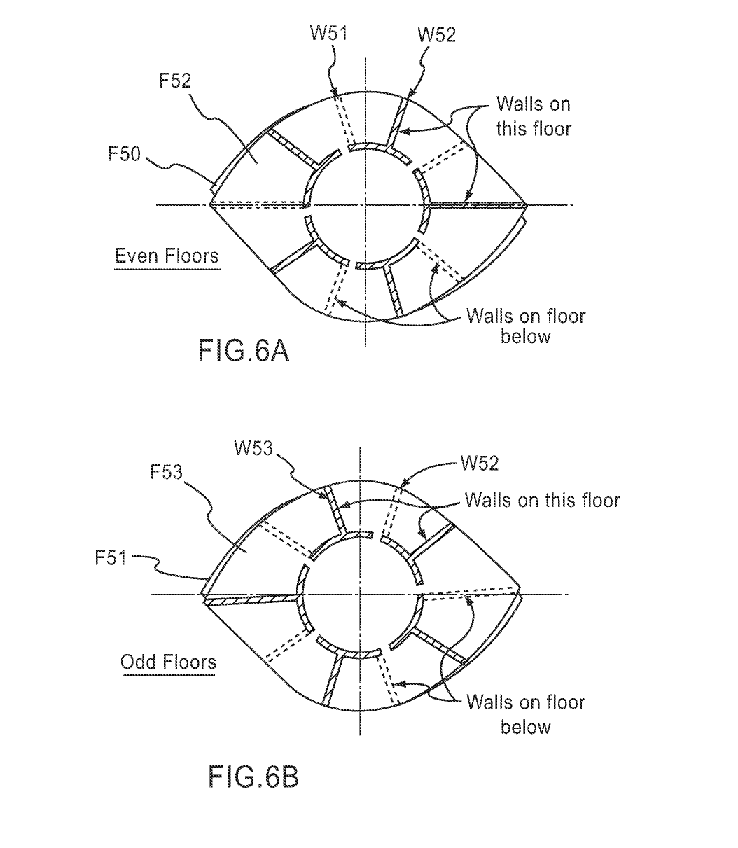

FIGS. 6A and 6B present overhead views of floors for a similar variation to that of FIGS. 3-5A, but with the floor profile being generally almond shaped, such that the slight twist between floors may be seen in the overlay of even and odd floors (e.g., see offset of even floors F50 and F52 and odd floors F51 and F53, as shown in FIGS. 6A and 6B, respectively). The floorplans of each of the even floors, as shown in FIGS. 6A and 6B, may be identical, or nearly identical, and the floorplans of each of the odd floors may be likewise identical, or nearly identical, with the even floor plans being nearly opposite in orientation, allowing for twist angle, to the vertically adjacent odd floor plans. As shown in FIG. 6B, the nearly opposite orientation of the odd and even floor plans allows for alternating support of the floor F53, for example, by the walls W53 from above and the walls W52 from below.

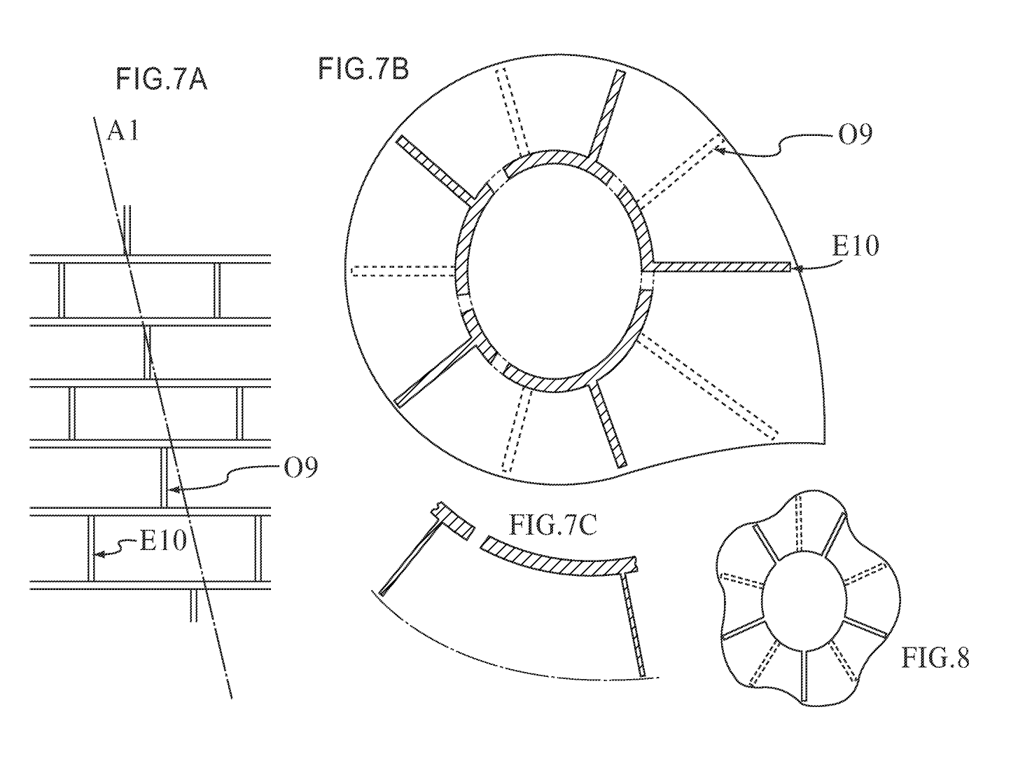

FIGS. 7A-7C show features and views of a generally tear-drop shaped profile for floors and various aspects of implementation relating thereto, including cross-braced cantilever wall portions usable with twisting buildings, in accordance with an aspect of the present invention. As shown in FIG. 7A, an elevational view of the floors illustrates the twist angle A1, taken along an offset vertical line of alternating floors, where A1 may range from 0° up to 100°. The offset cantilever walls E10 and O9 show an alternating support structure in which the cantilever walls E10, O9 alternate support between the even floors and the odd floors by approximately one-half of an apartment length, for example. FIG. 7B shows that the same support walls E10, O9 may be of varying lengths to permit construction of structures of varying shapes. As shown in FIG. 7C, a top view of a typical room space shows that the cantilever walls permit an open column-free space. Although shown in FIG. 7C as having a circumferential dimension of 20 meters and a radial dimensional range of 8-12 meters, the range of configurations for any individual open space is limited only by the principles of engineering design for the material being used, as is well known in the art.

FIG. 8 illustrates an aspect of the present invention in accordance to which the structure may comprise a limitless variation of cross-sectional shapes due to the ability to provide different length cantilever walls. As such, an individual space may include balconies or various other design features as suitable for the use and purpose of the structure.

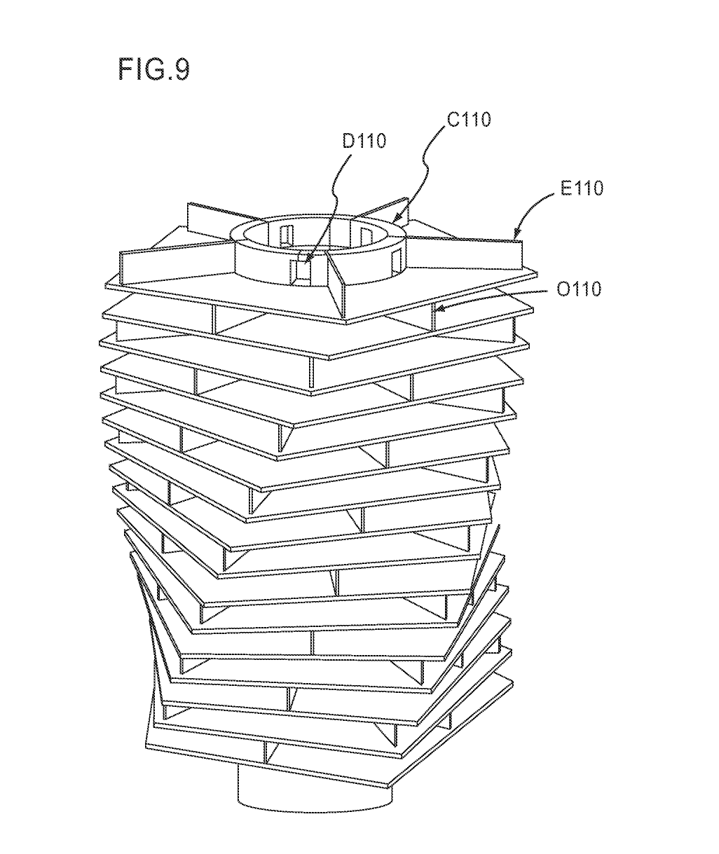

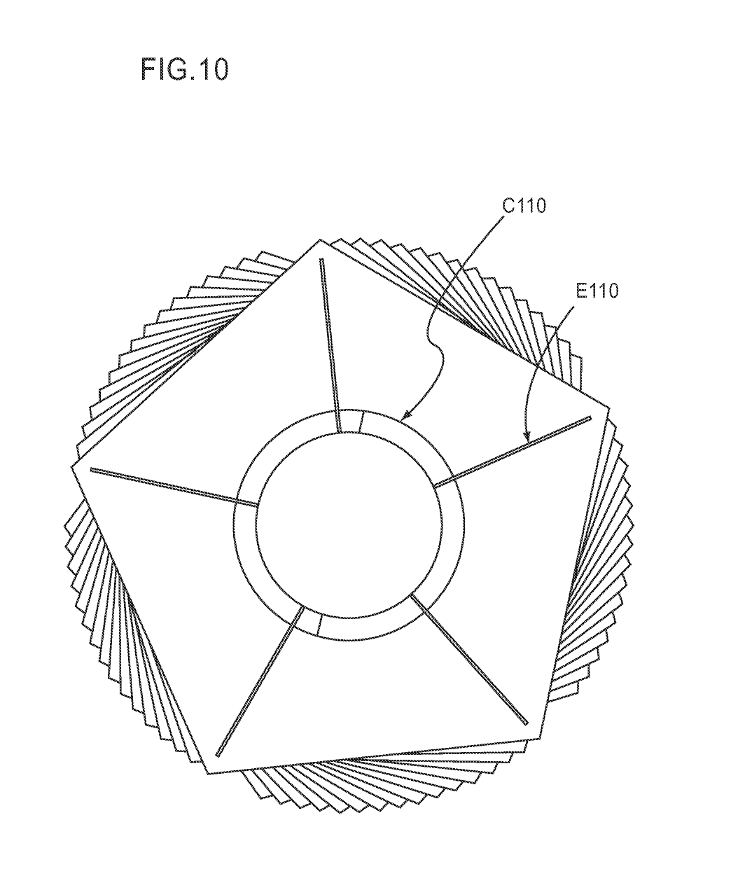

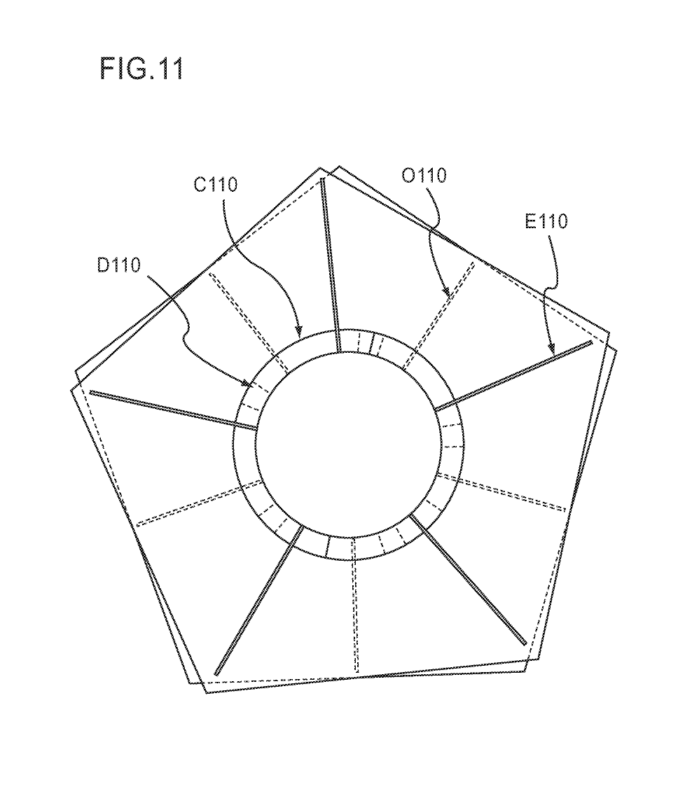

FIGS. 9-11 present perspective and overhead views of a generally pentagon-shaped profile for floors usable in twisting buildings, in accordance with aspects of the present invention. As shown in FIGS. 9 and 11, the cantilever walls E110 may be configured to extend to the corners of the pentagon-shaped profile on every other floor, for example, while the cantilever walls O110 may extend to a center portion of each exterior side of the profile on each of the other alternating floors. The cantilever walls E110 and O110 extend from and are supported by the central core C110. Doors D110 may be provided as shown and described previously with respect to a vertically angle line, although the configuration for the doors D110 may be varied substantially according to the desired layout of apartments, for example.

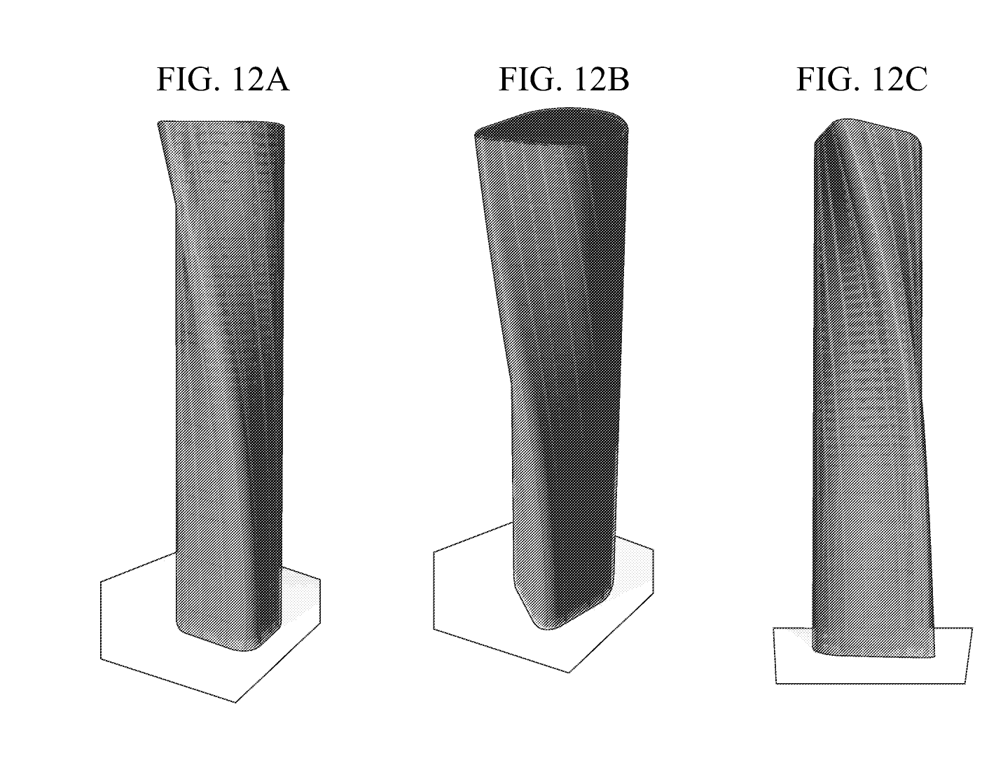

FIGS. 12A-12C show perspective views of an exemplary building designed in accordance with aspects of the present invention. As shown, the building has a generally tear-drop shaped cross-sectional profile.

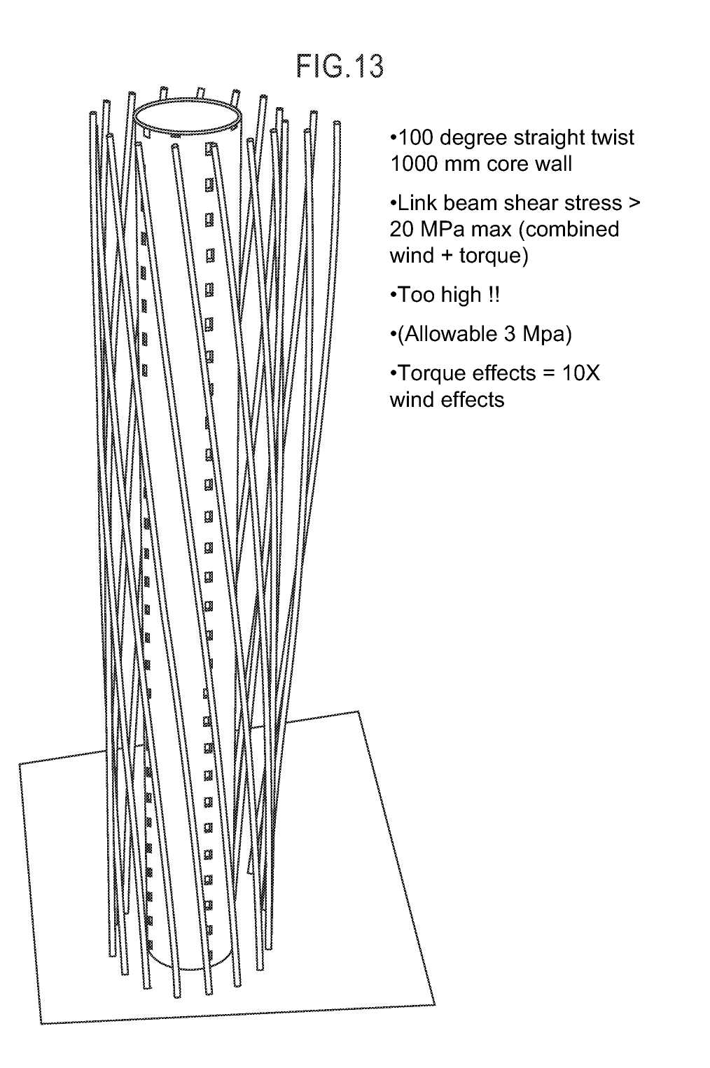

FIG. 13 shows rendering of a 100° twist as applied to a building with a generally tear-drop shaped cross-sectional profile having doors aligned vertically as is standard in the prevailing art. For example, FIG. 13 shows a column T1 of link beams that starts at a radial position of 0° as measured from the center of the central core at a point of column T1 along the base of the structure and twists radially through a total of 100° as measured from the center of the central core to a point of column T1 at the top of the structure. Parametric modeling of the structure shows that the torque effects of this design may be up unacceptable, up to ten times the wind effects.

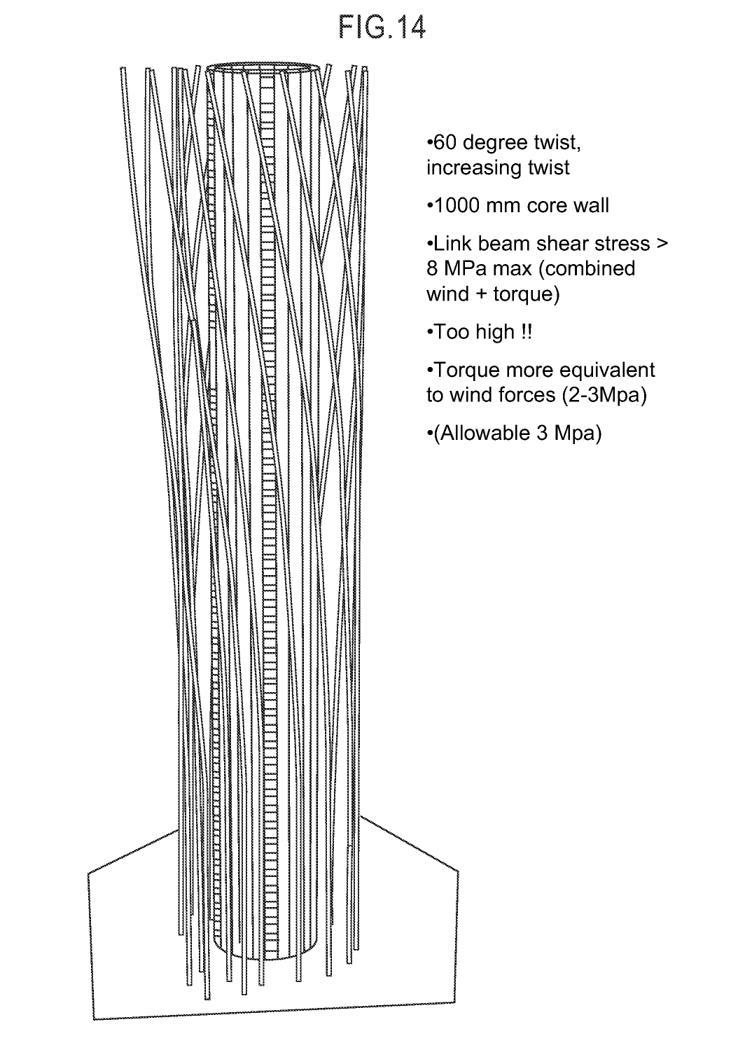

FIG. 14 shows a rendering of a 60° twist as applied to a building with a generally tear-drop shaped cross-sectional profile having doors aligned vertically as is standard in the prevailing art, where the twist angle increases from base to top. A parametric analysis of the structure shows that the torque effects of this design are more equivalent to the wind forces.

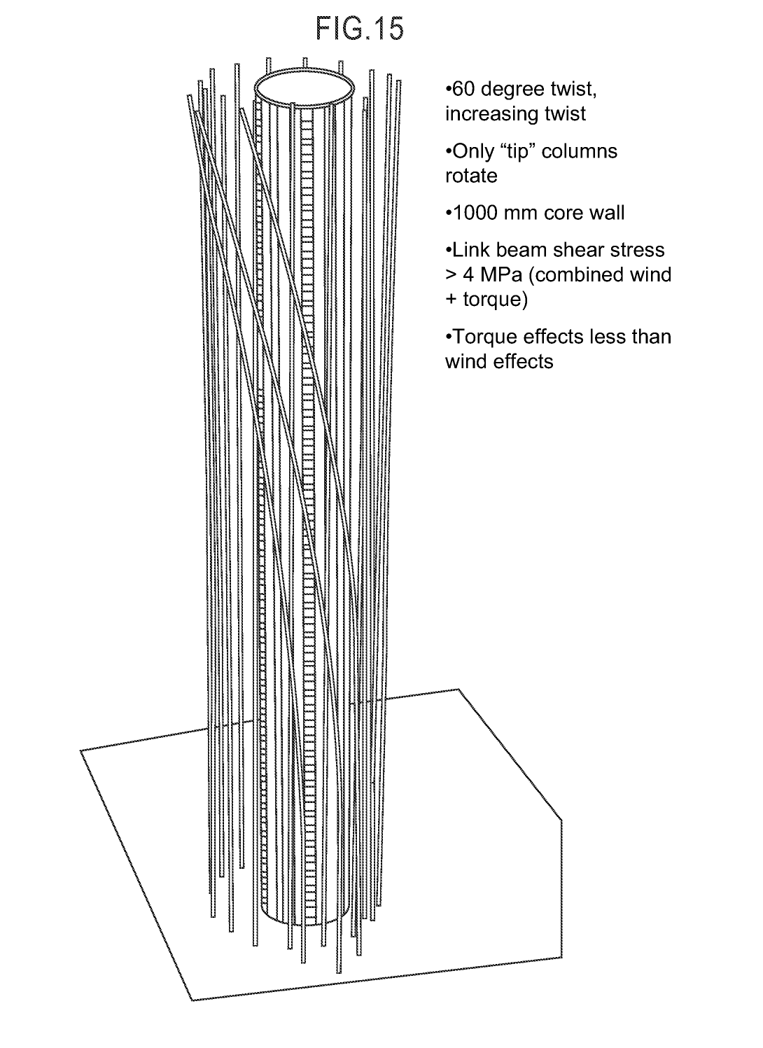

FIG. 15 shows a rendering of a 60° twist as applied to a building with a generally tear-drop shaped cross-sectional profile having doors aligned vertically as is standard in the prevailing art, where only “tip” columns rotate. A parametric analysis of the structure shows that the torque effects of this design are less than the wind effects.

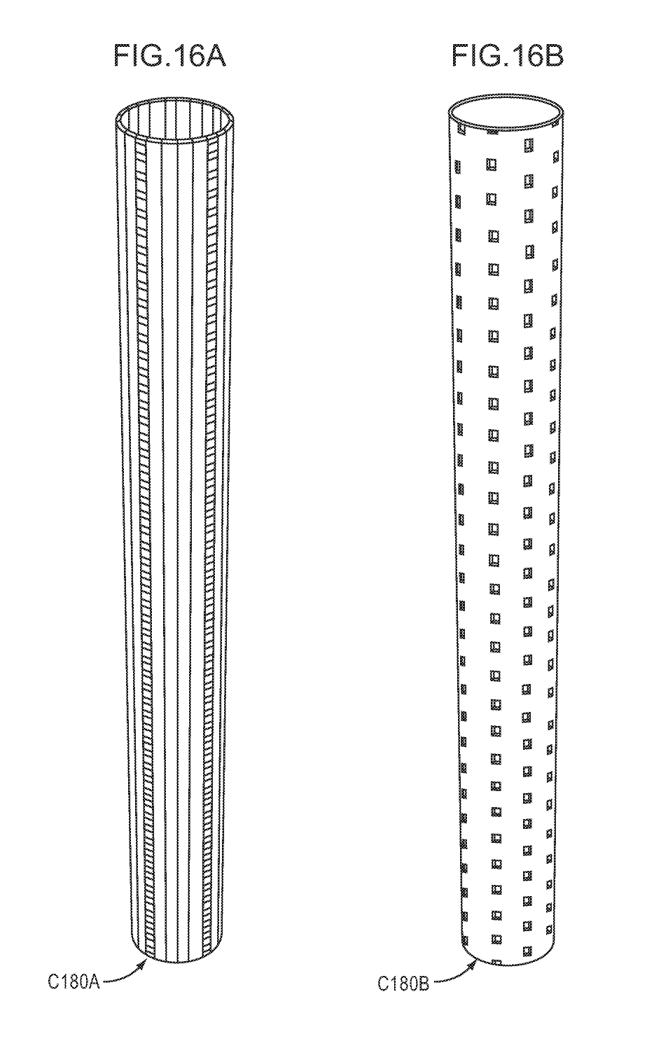

FIGS. 16A and 16B show a rendering of a central core 180A and 180B, respectively, in which the doors are staggered on alternating floors in the central core 180B. By designing the building with the staggered doors on alternating floors and using the cantilevered walls supporting the floors from above and below, aspects of the present invention reduce the stress levels experienced by the forces described above so that a twisting building construction becomes feasible.

While this invention has been described in conjunction with the exemplary aspects outlined above, various alternatives, modifications, variations, improvements, and/or substantial equivalents, whether known or that are or may be presently unforeseen, may become apparent to those having at least ordinary skill in the art. Accordingly, the exemplary aspects of the invention, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents.

What is claimed is:

1. A structure for a building, comprising:
a core wall structure;
a plurality of support walls, wherein the plurality of support walls are attached to the core wall structure and cantilever from the core wall structure;
a plurality of floor structures arranged vertically and attached to the core wall structure, wherein each floor structure is supported from below by a first set of the plurality of support walls and from above by a second set of the plurality of support walls, a position of the second set of the plurality of support walls being radially offset from a position of the first set of the plurality of support walls; and
a plurality of openings in the core wall, wherein at least one opening is provided between any two successive floor structures of the plurality of floor structures, and wherein alternating openings in a vertical direction are arranged to align along an angle of vertical offset.

2. The structure according to claim 1, wherein adjacent openings in a vertical direction are circumferentially offset approximately equally to the offset between the positions of the first set and the second set of the plurality of support walls.

3. The structure according to claim 1, wherein one or more of the plurality of support walls are of a differing length.

4. The structure according to claim 1, further comprising:
linking beams used to join a radial perimeter portion of successive floor structures of the plurality of floor structures.

5. The structure according to claim 1, each of the plurality of floor structures having a long span, further comprising:
an edge beam, wherein the edge beam provides additional support to the long span of at least one of the plurality of floor structures.

6. The structure according to claim 1, wherein each successive floor structure of the plurality of floor structures in the vertical direction is radially offset from the preceding one of the plurality of floor structures.

7. The structure according to claim 1, wherein each floor structure of the plurality of floor structures is configured to be in the shape of a tear-drop.

8. The structure according to claim 1, wherein each floor structure of the plurality of floor structures is configured to be in the shape of a pentagon.

9. The structure according to claim 1, wherein each floor structure of the plurality of floor structures is configured to be in the shape of an almond.

10. The structure according to claim 1, wherein the central core is circular in dimension.

11. The structure according to claim 10, wherein an elevator is provided to move within an interior portion of the central core.

12. A method of building a twisting structure, comprising:
constructing a central core;
building a plurality of cantilever walls connected to the central core;
constructing a plurality of floor structures arranged concentrically in a vertical fashion about the central core, wherein each floor structure of the plurality of floor structures is supported from above by a first set of the plurality of cantilever walls and is supported from below by a second set of the plurality of cantilever walls, wherein the first set of the plurality of cantilever walls attach to the floor structure at a position radially offset from a position where the second set of the plurality of cantilever walls attach to the floor structure; and
providing a plurality of openings in the core wall, wherein at least one opening is provided between any two successive floor structures of the plurality of floor structures, and wherein alternating openings in a vertical direction are arranged to align along an angle of vertical offset.

13. The method of building a twisting structure of claim 12, wherein adjacent openings in a vertical direction are circumferentially offset approximately equally to the offset between the positions of the first set and the second set of the plurality of cantilever walls.

14. The method of building a twisting structure of claim 12, wherein one or more of the plurality of cantilever walls are constructed to be of a different length.

15. The method of building a twisting structure of claim 12, wherein each successive floor structure of the plurality of floor structures in the vertical direction is constructed to be radially offset from the preceding floor structure of the plurality of floor structures below.

16. A method of designing a building structure, comprising:
specifying an orientation of a repeating geometric shape in the building structure, each of the repeating geometric shapes being illustrated in relation to one another; and
producing a design on a tangible medium, the design having the repeating geometric shape;
wherein the building structure comprises:
a core wall structure;
a plurality of support walls, wherein the plurality of support walls are attached to the core wall structure and cantilever from the core wall structure;
a plurality of floor structures arranged vertically and attached to the core wall structure, wherein each floor structure is supported from below by a first set of the plurality of support walls and from above by a second set of the plurality of support walls, a position of the second set of the plurality of support walls being radially offset from a position of the first set of the plurality of support walls; and
a plurality of openings in the core wall, wherein at least one opening is provided between any two successive floor structures of the plurality of floor structures, and wherein alternating openings in a vertical direction are arranged to align along an angle of vertical offset.

17. The method of designing a building structure of claim 16, wherein the design further includes adjacent openings of the building structure in a vertical direction being circumferentially offset approximately equally to the offset between the positions of the first set and the second set of the plurality of cantilever walls.

18. A design document produced using the method of claim 16.
